(19) United States
(12) Patent Application Publication
(10) Pub. No.: US 2009/0210816 A1
(43) Pub. Date: Aug. 20, 2009

(54) SWITCHABLE PANEL LAYOUT EXTENSION

(75) Inventor: Robert C. Ingebretsen, Bothell, WA (US)

Correspondence Address: LEE & HAYES, PLLC, 601 W. RIVERSIDE AVENUE, SUITE 1400, SPOKANE, WA, 99201, US

(73) Assignee: IDENTITYMINE INC., Tacoma, WA (US)

(21) Appl. No.: 12/034,532

(22) Filed: Feb. 20, 2008

(51) Int. Cl. G06F 3/048

(52) U.S. Cl. 715/778

(57) ABSTRACT

Techniques for arraigning elements on a panel are disclosed. The technique includes defining attributes for user interface elements in a switch panel, defining a layout algorithm in switchable panels, and calling the layout algorithm in each of the switchable panels from the switch panel. The user interface elements are repositioned using the algorithm in the called switchable panel.

### BACKGROUND

This application relates to extending a Windows Presentation Foundation (WPF) layout API and more particularly an API for a switchable panel layout extension that allows dynamic switching between different layout strategies at runtime.

WPF is Microsoft's presentation subsystem for .NET 3.0 which is a key part of Microsoft Windows Vista operating system. WPF provides an application programming interface (API) for handling layout of elements (where layout is defined as assigning position and size to a group of elements or objects, and the layout engine is the mechanism for handling the layout). This API is encapsulated in a control called a Panel. A Panel contains a collection of elements on which it performs layout. These elements are generally referred to as children.

Generally, each Panel represents a single layout. Example layouts for the elements include stacking (StackPanel), absolute positioning (Canvas) or table layout (Grid). The layout represented by a Panel is dynamic and is regularly recalculated in response to any event which “invalidates” layout. Examples of the events that invalidate the layout include the Panel being resized or a size of the elements in the Panel being changed.

A layout strategy for a Panel is typically defined in the logic of two methods on the Panel. The first of these methods, called Measure, is used to evaluate the size of each element in a Children collection. The second method, called Arrange, is used to assign an actual size and location to each element in the Children collection.

A layout engine in WPF is normally encapsulated by a single Panel and changing a layout at runtime requires removing elements from one Panel and added the removed elements into another Panel. This encapsulation makes the addition of features to the layout engine such as “layout-to-layout” animation very difficult or impossible.

### SUMMARY

The Switchable panel layout extension and techniques described herein extends the existing WPF Panel infrastructure with the ability to dynamically “switch” between different layout engines at runtime. The Switchable panel keeps the elements inside of a single Panel and uses a pluggable “layout engine” infrastructure to perform layout strategies on those elements. These techniques make it possible to dynamically change the layout strategy that is in use at runtime. These techniques also enable scenarios such as “layout-to-layout animations,” data visualizations or other user interface (UI) scenarios involving dynamically changing layouts.

Each of the layout engines employed by a Switch Panel is encapsulated by elements which are derived from a Switchable Panel. The Switchable Panel introduces a methodology for decoupling its layout logic from the elements that it contains while still maintaining its ability to be used as a standalone Panel.

### BRIEF DESCRIPTION OF THE DRAWINGS

The detailed description is described with reference to the accompanying figures. In the figures, the left-most digit(s) of a reference number identifies the figure in which the reference number first appears. The use of the same reference number in different figures indicates similar or identical items.

FIG. 1 is an example block diagram in which there is shown calls between different panels in WPF to implement a switchable panel layout.

FIG. 2 is a block diagram depicting selected modules in a computer device that invokes the WPF calls to implement the switchable panel layout.

FIG. 3 is a diagram of an exemplary process used to implement the switchable panel layout extension.

FIGS. 4a-4c are diagrams of an exemplary panel displays that are rendered using the switchable panel extension.

### DETAILED DESCRIPTION

This disclosure is directed to techniques for implementing a switchable panel layout extension.

According to one implementation, a method is provided for arranging elements in a panel. The method includes attributes for user interface elements in a switch panel and defining a layout algorithm in each of a plurality of switchable panels. The layout algorithm is called in each of a plurality of switchable panels from the switch panel. The user interface elements are repositioned using the algorithm in the called switchable panel, the defined location and the defined size.

According to another implementation, a method for updating panel in Windows Presentation Foundation (WPF) is provided. The method includes assigning WPF attributes for user interface elements in a WPF switch panel. A layout strategy is defined in each of a plurality of switchable panels and the assigned interface elements are passed to the layout strategy in each of a plurality of switchable panels from the switch panel. The user interface elements are repositioned in the WPF switch panel using the layout strategy in the called switchable panel.

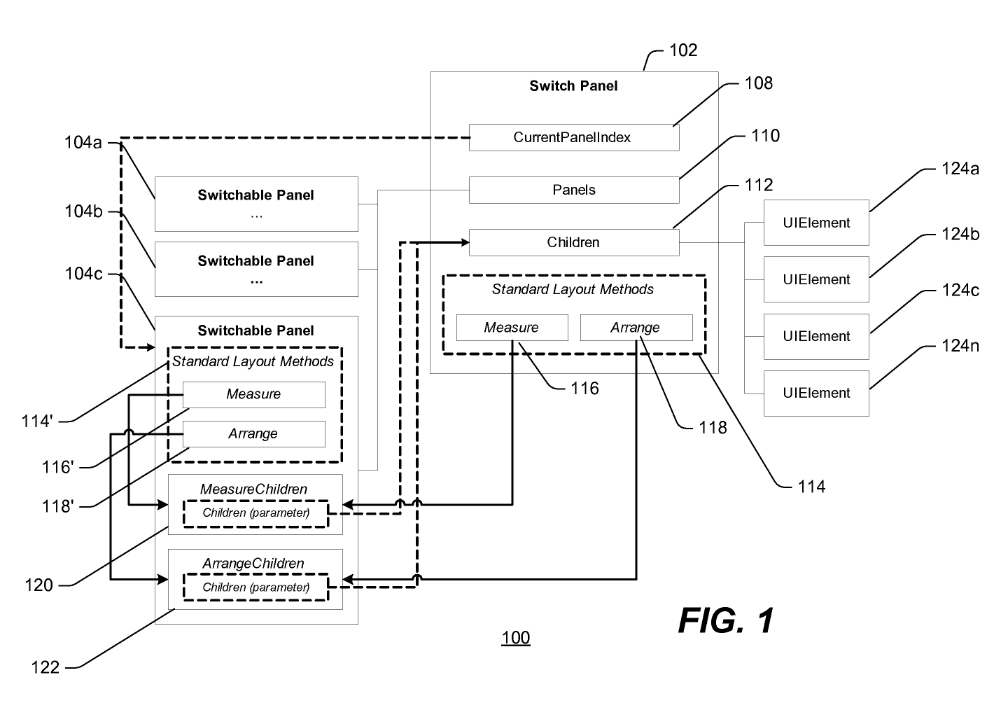

Various examples of the switchable panel layout extension are described below with reference to FIGS. 1-4.

FIG. 1 illustrates an example block diagram 100 in which there is shown calls between different panels in WPF. Block diagram includes Switch panel 102 interacting with Switchable panels 104a-104c, and passing UI elements 106a-106d. Switch Panel 102 includes a Current Panel Index 108, panels 110, children 112 (also referred to herein as the Children Collection) and standard layout methods 114 that include Measure block 116 and Arrange blocks 118.

Switchable panels 104a-104c each include the standard layout methods 114′ that incorporate the Measure block 116′ and arrange block 118′. Switchable panels 104a-104c also include a Measure Children Block 120 and an Arrange Children block 122. Each of the switchable panels may have a unique layout algorithm compared to the other panels.

Children block 112 include user interface elements 124a-124n which contain parameters or objects that draw the current panel.

Switch Panel 102 derives from the built in WPF Panel class and has, therefore, a collection of objects (Children 112) that it is responsible for “laying out” (i.e. placing and sizing within the physical space it occupies). Switch Panel 102 also maintains a collection of layout engines (Panels 110), each of which encapsulates a strategy for performing layout (also referred to herein as Switchable Panels 104a-104n). Switch Panel 102 keeps a user-settable pointer to the “current” layout engine in the collection of Panels 110.

Switch Panels 102 takes advantage of the decoupled nature of layout in each of Switchable Panels 104a-104c to make it possible to change the layout engine that Switch Panel 102 employs at any given moment during runtime. Switch Panel 102 also maintains an index into the “current” panel called Current Panel index 108. Current Panel index 108 indicates the current panel.

By convention, Switch Panel 102 (like other Panels) handles layout in its Measure and Arrange methods. In these methods, Switch Panel 102 defers the layout to the “current” Switch Panel from the Panels collection 110 by calling a MeasureChildren 120 and ArrangeChildren 122 methods of a Switchable panel 114′. Switch Panel 102 passes in the Switch Panel's own Children collection 112 as the Children parameter to the MeasureChildren 120 and ArrangeChildren 122 methods. The result of this passing (or calling) is that the current Switchable Panel (e.g. Switchable Panel 104c) can handle the layout for the objects in the Children 112 collection of Switch Panel 102 by proxy. If the CurrentPanelIndex 108 is updated at runtime, such as by a selection of a user, the current layout of the elements in the panel is invalidated forcing the layout logic to be executed again, now using the layout logic of the newly selected Switchable Panel (e.g. Switchable Panel 104a or 104b).

Each layout engine is derived from the type Switchable Panel. The type Switchable Panel introduces the methods MeasureChildren 120 and ArrangeChildren 122 which correspond to the standard layout methods Measure 116 and Arrange 118. The difference, however, is that where Measure 116 and Arrange 118 expect to perform layout on the Children collection 112 of the object where they are defined, the new methods (MeasureChildren 120 and ArrangeChildren 122) introduce a new parameter to the methods called Children 112 which is a pointer to an external collection of objects on which layout is to be performed.

Standard Layout Methods 114 includes a Measure 116 and Arrange block 118. When the standard Measure 114 and Arrange 116 methods are called on Switch Panel 102, Switch Panel 102 simply calls the corresponding method (either MeasureChildren 120 or ArrangeChildren 122) on the currently selected layout engine in its Panels 110 collection and passes in its own Children collection 112 to that method. This passing allows Switch Panel 102 to defer layout to the currently selected layout engine.

Switchable Panel 102 itself, when used as a standalone Panel, also defers the layout of its own Children collection 112 to the MeasureChildren 120 and ArrangeChildren 120 methods.

In this implementation, Switchable Panel 104c derives from Panel 110, the standard WPF layout container. The Switchable Panel 104c defines two abstract methods MeasureChildren 120 and ArrangeChildren 122. These methods are closely related to their counterparts Measure 116 and Arrange 118. The intention is that any layout logic which would normally be implemented in Measure can be implemented in MeasureChildren 120. Similarly, any layout logic which would normally be implemented in the Arrange 118 method can be implemented in ArrangeChildren 122.

The difference between the original method (Measure 116 or Arrange 118) and its counterpart (MeasureChildren 120 or ArrangeChildren 122) is that the latter method takes an additional parameter called Children 112. This is a type of UI Element Collection 124a-124n that is the same type as the Children property on Panel 110. Any layout logic performed in MeasureChildren 120 or ArrangeChildren 112 is performed on elements in the Children collection 112, which is passed into the method as a parameter. By using this method, the layout logic defined in these methods can be accessed by external objects. Specifically, this method makes it possible for Switch Panel 102 to defer the layout of its children to the layout engine encapsulated each of Switchable Panels 104a-104c.

When one of Switchable Panels 104a-104c is used as a standalone panel, it is required by convention to actuate its layout logic in the original Measure 116 and Arrange 118 methods. To avoid duplicating this layout logic, these methods defer to the corresponding MeasureChildren 120 or ArrangeChildren 122 methods by passing Children 112 for the Children parameter in the new method as described herein:

```
class SwitchablePanel : Panel
{
protected override Size ArrangeOverride(Size size)
{
  return Arrange(Children, size);
  }
  protected override Size MeasureOverride(Size size)
  {
return Measure(Children, size);
}
}
```

### Example System Architecture

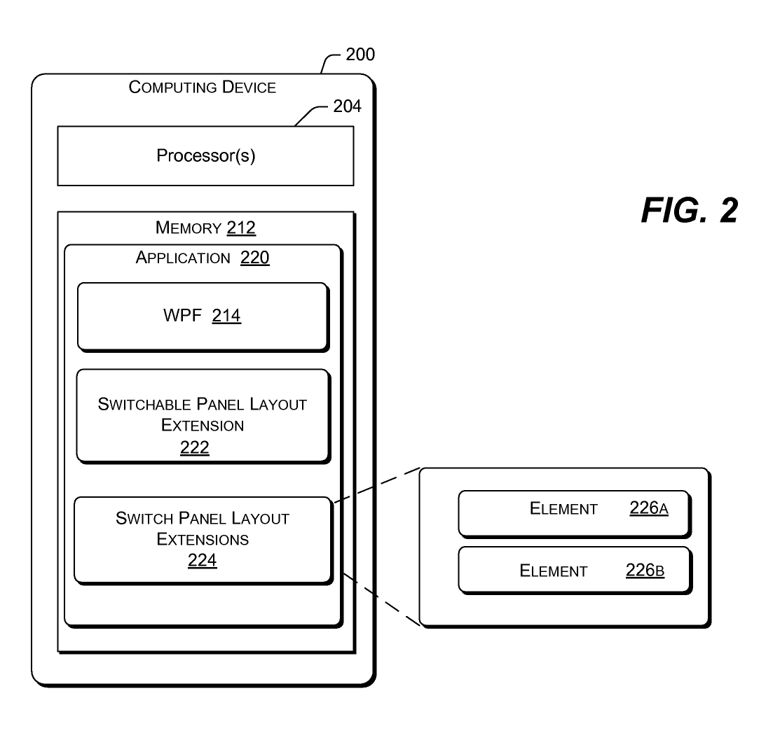

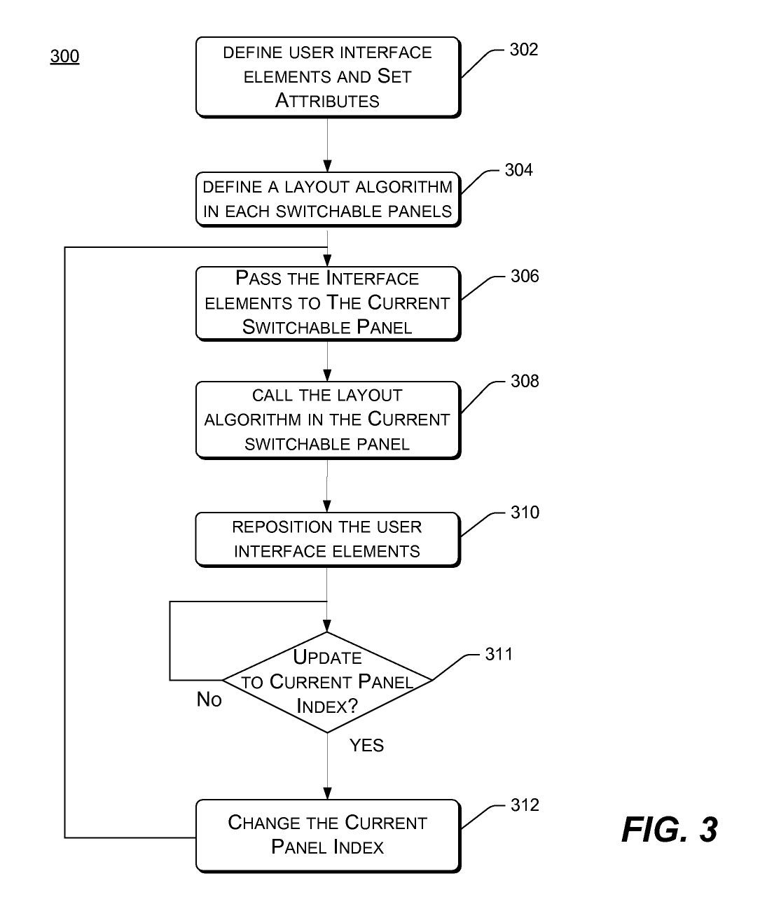

In FIG. 2 are illustrated selected modules in computing device 200 using process 300 shown in FIG. 3. Computing device 200 has process capabilities and memory suitable to store and execute computer-executable instructions. In one example, computing device 200 includes one or more processors 204 and memory 212.

The memory 212 may include volatile and nonvolatile memory, removable and non-removable media implemented in any method or technology for storage of information, such as computer-readable instructions, data structures, program modules or other data. Such memory includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and which can be accessed by a computer system.

Stored in memory 212 of the computing device 200 a software application 220. Software application 220 at runtime includes Windows Presentation Foundation 214 with an operating system (Such as a Window® Vista based operating system), switchable panel layout extension 222 (Switch Panel 102 of FIG. 1) and switch panel layout extension 224 (Switchable Panels 104a-104c of FIG. 1). Switch Panel Layout Extension 224 includes exemplary elements 226a-226b (UI Elements 124a-124n of FIG. 1). Elements 226 contain attributes of various objects, including but not limited to, size, color, or orientation.

Illustrated in FIG. 3, is a process 300 for switching panels using layout extensions. The exemplary process in FIG. 3 is illustrated as a collection of blocks in a logical flow diagram, which represents a sequence of operations that can be implemented in hardware, software, and a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the processes are described with reference to FIG. 1-FIG. 3, although it may be implemented in other system architectures.

FIG. 3 shows the process 300 of a switch panel 102 with switchable panels (104a-104d) using the processor and modules shown in FIG. 2. In block 302, prior to operation user interface elements are defined and attributes are set for the defined UI elements in a WPF switch panel. In block 304, a layout strategy (or algorithm) in each of the switchable panels are defined. In block 306, the assigned interface elements are passed to the layout strategy in the current switchable panel from the switch panel, and in block 308 the layout algorithms in the current switchable panel are called. In block 310, the user interface elements are re-positioned.

In block 311, a determination is made whether there is a request to update the current panel index. If there is no update current index panel request (“No” to block 311), then block 311 is repeated. If a there is a request to update the current panel index (“Yes” to block 312), then in block 312 the current panel index is updated. The process may then be repeated by restarting at block 306 where the assigned interface elements are passed to the layout strategy in each of a plurality of switchable panels from the switch panel.

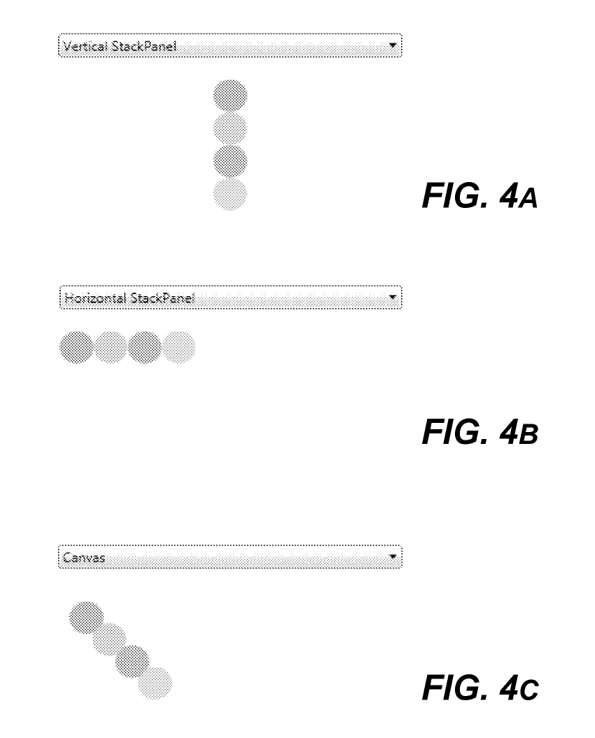

FIG. 4a-4c disclose sample panels that are repositioned using the previously described techniques and the following XAML markup.

The following XAML markup is an example of using the Switch Panel technique to dynamically switch between three layouts: a Canvas, a vertically oriented StackPanel and a horizontally oriented StackPanel (each of which examples of Switchable Panel objects).

```
    <ComboBox x:Name=“cb” SelectedIndex=“0” Margin=“0,0,0,20”>
      <ComboBoxItem>Canvas</ComboBoxItem>
      <ComboBoxItem>Vertical StackPanel</ComboBoxItem>
      <ComboBoxItem>Horizontal StackPanel</ComboBoxItem>
    </ComboBox>
    <im:SwitchPanel
      CurrentPanelIndex=“{Binding ElementName=cb,Path=
SelectedIndex, Mode=TwoWay}”>
      <im:SwitchPanel.Panels>
        <im:Canvas />
        <im:StackPanel Orientation=“Vertical” />
        <im:StackPanel Orientation=“Horizontal” />
      </im:SwitchPanel.Panels>
      <Ellipse c:Canvas.Left=“10” c:Canvas.Top=“10” Fill=“Orange” />
      <Ellipse c:Canvas.Left=“30” c:Canvas.Top=“30” Fill=“Gold” />
      <Ellipse c:Canvas.Left=“50” c:Canvas.Top=“50”
Fill=“YellowGreen” />
      <Ellipse c:Canvas.Left=“70” c:Canvas.Top=“70”
      Fill=“LightBlue” />
    </im:SwitchPanel>
```

The images show in FIGS. 4a-4c are image renderings of the above XAML with each of the three difference layouts selected. From the XAML code, the use of all components of an exemplary Switch Panel is shown. The im:SwitchPanel is the SwitchPanel control itself, the im:Canvas and the two im:StackPanels are implementations of Switchable Panel, i.e. a control which encapsulates the deferred layout strategy used by a Switch Panel.

Each of the Switchable Panels is contained in the im:SwitchPanel.Panels collection, the collection of SwitchablePanels which encompasses the available layout strategies for this instance of SwitchPanel. The im:SwitchPanel.CurrentPanelIndex is an index into the Panels collection which represents the layout engine which is currently in use.

Note that the three images generated in FIG. 4a-4c were generated in a single instance of the application with no code behind. The CurrentPanelIndex property was updated via a Binding to the SelectedIndex property of the ComboBox.

An example of using a Switchable Panel as a Standalone Panel is shown below and rendered in FIG. 4c. This example shows how an individual panel (im:Canvas), which served as a layout engine in the previous example, can be used as a standalone panel. The XAML code for the Switchable Panel is as follows:

```
    <im:Canvas>
      <Ellipse c:Canvas.Left=“10” c:Canvas.Top=“10” Fill=“Orange” />
      <Ellipse c:Canvas.Left=“30” c:Canvas.Top=“30” Fill=“Gold” />
      <Ellipse c:Canvas.Left=“50”
c:Canvas.Top=“50” Fill=“YellowGreen” />
      <Ellipse c:Canvas.Left=“70” c:Canvas.Top=“70”
      Fill=“LightBlue” />
    </im:Canvas>
```

### CONCLUSION

In closing, although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method for arraigning elements on a panel, the method comprising:
defining a user interface elements and set attributes in a switch panel;
defining a layout algorithm in each of a plurality of switchable panels;
calling the layout algorithm in each of a plurality of switchable panels from the switch panel; and
repositioning the user interface elements using the algorithm in the called switchable panel, the defined location and the defined size.

2. The method as recited in claim 1 wherein each of the plurality of switchable panels has a unique layout algorithm.

3. The method as recited in claim 1 further comprising:
defining attributes for user interface elements in one of the plurality of switchable panels;
calling the layout algorithm in another switchable panels from the one of the plurality of switchable panels; and
repositioning the user interface elements using the algorithm in the called another switchable panel, using the defined location in the one of the plurality of switchable panels and the defined size in the one of the plurality of switchable panels.

4. The method as recited in claim 1 wherein the algorithm comprises a measure algorithm that evaluates the size for one of the user interface elements, and an arrange algorithm that assigns an actual size and location to each one of the user interface elements.

5. The method as recited in claim 1 further comprising:
defining a current panel index which indicates the plurality of switchable panels that can be called;
designating a switchable panel in the index;
calling the layout algorithm in the designated switchable panel of a plurality of switchable panels from the switch panel; and
repositioning the user interface elements using the algorithm in the called designated switchable panel, the defined location and the defined size.

6. A method for updating panel in Windows Presentation Foundation (WPF), the method comprising:
assigning an attributes to user interface elements in a WPF switch panel;
defining a layout strategy in each of a plurality of switchable panels;
passing the assigned interface elements to the layout strategy in each of a plurality of switchable panels from the switch panel; and
repositioning the user interface elements in the WPF switch panel using the layout strategy in the called switchable panel.

7. The method as recited in claim 6, wherein each of the plurality of switchable panels has a unique layout algorithm.

8. The method as recited in claim 6 further comprising:
assigning WPF attributes for user interface elements in one of the plurality of switchable panels;
defining the layout strategy in another switchable panel from the one of the plurality of switchable panels;
passing the assigned user interface elements to the layout strategy in one of the plurality of switchable panels; and
repositioning the user interface elements in the WPF switch panel using the layout strategy in the one of the plurality of switchable panels.

9. A computer readable medium comprising computer-executable instructions for arraigning elements in a panel that, when executed by one or more processors, perform acts comprising:
defining attributes for user interface elements in a switch panel;
defining a layout algorithm in each of a plurality of switchable panels;
calling the layout algorithm in each of a plurality of switchable panels from the switch panel; and
repositioning the user interface elements using the algorithm in the called switchable panel, the defined location and the defined size.

10. The computer readable medium as recited in claim 9 further comprising:
defining attributes for user interface elements in one of the plurality of switchable panels;
calling the layout algorithm in another switchable panels from the one of the plurality of switchable panels; and
repositioning the user interface elements using the algorithm in the called another switchable panel, using the defined location in the one of the plurality of switchable panels and the defined size in the one of the plurality of switchable panels.

11. The computer readable medium as recited in claim 10, wherein the user interface elements are repositioned by stacking the elements, arraigning the elements in a horizontal position or arraigning the elements along a diagonal.
